(19) United States
(12) Patent Application Publication
(10) Pub. No.: US 2014/0297831 A1
(43) Pub. Date: Oct. 2, 2014

(54) CONTINUOUS IMPROVEMENT OF GLOBAL SERVICE DELIVERY AUGMENTED WITH SOCIAL NETWORK ANALYSIS

(71) Applicant: INTERNATIONAL BUSINESS MACHINES CORPORATION, Armonk, NY (US)

(72) Inventors: Shivali Agarwal, Ghaziabad (IN); Benjamin P. Chance, Singapore (SG); Yi-Min Chee, Yorktown Heights, NY (US); James S. Gardner, Bedford, TX (US); Eleanor A. Hurst, Fort Lauderdale, FL (US); Juhnyoung Lee, Yorktown Heights, NY (US); Rong Liu, Sterling, VA (US); Vinay K. Reddy, Bangalore (IN); Bikram Sengupta, Bangalore (IN); Renuka R. Sindhgatta, Bangalore (IN); Lav R. Varshney, Yorktown Heights, NY (US)

(73) Assignee: International Business Machines Corporation, Armonk, NY (US)

(21) Appl. No.: 13/851,514

(22) Filed: Mar. 27, 2013

(51) Int. Cl. H04L 12/26

(52) U.S. Cl. CPC H04L 43/10
USPC 709/224

(57) ABSTRACT

Improving global service delivery by augmenting with social network analysis, may comprise identifying social network metrics and key performance indicator metrics; collecting data associated with the social network metrics and the key performance indicator metrics, from on-going work performed in the global service delivery and a social network of practitioners; transforming the data into measurable metric data; determining whether a deviation exists in the measurable metric data; and generating an actionable recommendation in response to determining that the deviation exists.

### FIELD

The present application relates generally to computers, and computer applications, and more particularly to operations and performance in global service delivery system, which may include application assembly optimization for globally integrated capabilities, and improvement thereof.

### BACKGROUND

Existing systems offer limited capability in providing continuous improvement in operation and process in global service delivery. For instance, delivery excellence is typically measured through various types of metrics. In the current practice, the metrics are limited to traditional performance indicators for operation and process, e.g., the tasks of monitoring and improving are limited to managers and leads. In addition, practitioners typically do not have visibility into how projects, which they are working on, fare against the metrics. Furthermore, there is typically no centralized, real-time view of delivery excellence metrics. That information, for instance, is shared only by special requests or as historical data.

The inventors in the present disclosure have recognized that global delivery systems at present do not exploit the social networks that emerge out of communities and forums in augmenting the knowledge about the practitioners. For instance, shared delivery systems have atypical social network requirements where it may be desirable to have less communication for each work packet. However, little has been studied or done about the shared delivery social networks for monitoring and improving upon the shared delivery systems.

### BRIEF SUMMARY

A method of improving global service delivery by augmenting with social network analysis, in one aspect, may comprise identifying social network metrics and key performance indicator metrics. The method may also comprise collecting data associated with the social network metrics and the key performance indicator metrics, from on-going work performed in the global service delivery and a social network of practitioners. The method may further comprise transforming the data into measurable metric data. The method may also comprise determining whether a deviation exists in the measurable metric data. The method may further comprise generating an actionable recommendation in response to determining that the deviation exists.

A system for improving global service delivery by augmenting with social network analysis, in one aspect, may comprise a data collection subsystem operable to execute on one or more processor, and further operable to instrument code to collect data associated with pre-identified social network metrics and key performance indicator metrics. A data transformation subsystem may be operable to execute on the one or more processor, and further operable to transform the data into measurable metric data. A data analysis subsystem may be operable to execute on the one or more processor, and further operable to determine whether a deviation exists in the measurable metric data. A recommendation subsystem may be operable to execute on the one or more processor, and further operable to generate an actionable recommendation in response to determining that the deviation exists.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating creation of a social network in a global delivery system in one embodiment of the present disclosure.

FIGS. 2A, 2B, 2C and 2D illustrate building of a social network of practitioners, e.g., developers or delivery engineers, in one embodiment of the present disclosure.

FIG. 3 illustrates a global service delivery system in one embodiment of the present disclosure.

FIG. 4 illustrates a global service delivery monitoring and recommendation system comprising a global delivery model that continuously monitors ongoing work for improvement in one embodiment of the present disclosure.

FIG. 5 is a flow diagram illustrating a method of global delivery monitoring and recommendation system implementing continuous improvement by using SNA and traditional metrics analysis in one embodiment of the present disclosure.

FIG. 6 is another diagram illustrating a method of global delivery monitoring and recommendation system implementing continuous improvement by using SNA and traditional metrics analysis in one embodiment of the present disclosure.

FIG. 7 illustrates a schematic of an example computer or processing system that may implement the monitoring system in one embodiment of the present disclosure.

### DETAILED DESCRIPTION

In one aspect, continuous improvement of the operation and performance in global service delivery may be provided by complementing the traditional analysis (e.g., using performance indicators) with social network analysis. In another aspect, a data-driven system for instrumentation, collection, transformation, analysis and reporting of data as well as actionable recommendation to optimize work allocation and team formation may be provided for continuous improvement.

In one embodiment of the present disclosure, methodologies such as performance indicator analysis and social network analysis may be applied to a domain of global service delivery, e.g., to improve solutions to work allocation and team formation.

A global service delivery model refers to a model used by one or more companies engaged in information technology (IT) consulting and services delivery business to execute a technology project using globally distributed resources. A global service delivery model may address technical skills, process rigor, tools, methodologies, overall structure and strategies for delivering IT-enabled services from global locations. A global service delivery model may assemble or integrate various computer applications, e.g., in an optimized manner, for delivering services to a customer globally, e.g., from globally distributed locations. Such application assembly optimization represents an industrialized approach to application development and maintenance.

Ongoing improvement of the operation and performance in global service delivery of the present disclosure may augment the traditional methods that employing key performance indicators (KPIs) for gauging performance, with social network analysis (SNA). In one embodiment of the present disclosure, the implicit social network formed due to communities and forums that practitioners use to communicate and collaborate is used to discover and infer knowledge. In another embodiment of the present disclosure, a graph structure representing a social network of practitioners and their relationships gleaned from such communities and forums that practitioners use to communicate and collaborate, is built for social network analysis.

Continuous improvement of the operations and performance in shared service delivery may be provided by monitoring the interactions between practitioners using tailor-made SNA that considers the shared delivery specific concepts like core and non-core teams. The interpretations of SNA metrics is done as per shared delivery expectations of team and individual behavior in accordance with the work that is typically carried out using such a shared resource model.

A data-driven system may be implemented for instrumentation, collection, transformation, analysis and reporting of data as well as recommendation of actionable adjustment to ensure continuous improvement. Reports may be automatically posted on project communities in terms of performance with respect to operations KPIs. Such real time sharing may be done to bring in more transparency, hence more responsibility and also to provide an opportunity to perform corrective actions based on observing other projects that may be faring better. Such a system reduces the possibilities of manual data manipulation to mask irregularities, if any.

A monitoring system may be provided for optimizing work allocation and team formation for continuous improvement. Work may be tracked and warnings may be triggered in case a likelihood of a possible deviation from the plan (e.g., original work plan) is detected. Such warnings help in optimizing work allocation by taking timely corrective measures. Social networks within organization are good indicators of team functioning. For example, the inputs from SNA can be used to optimize the teams to ensure high levels of productivity.

Examples of key performance indicators may include, but are not limited to, productivity, utilization, project spread, estimation accuracy, load balancing, and service level objective (SLO).

Productivity KPI, for example, may measure how the productivity is improving, given a tuple comprising <task type, skill level, role>. That is, the actual time spent should reduce with time. Various forms of productivity can be captured. One embodiment of the present disclosure uses the notion that suits the factory notion of productivity.

Utilization KPI, for example, may measure planned hours per available hours. This is indicative of the capacity gap and glut in the system. The lack of this indicator is related to process or tool deficiency in one embodiment of the present disclosure.

Project Spread KPI, for example, may measure the number of projects a cell (team corresponding to a skill) has worked on for the duration of study. This KPI indicates that the services are actually being delivered in a shared manner.

Estimation accuracy KPI, for example, may measure the number of tasks that have deviated from the estimated effort and the extent of the deviation (e.g., by how much delay, etc.).

Load Balancing KPI, for example, may measure the total planned hours. For instance, the work should get distributed in a balanced manner. This metric is useful in judging the quality of automatic work assignment, for example, across practitioners and across cells.

SLO KPI, for example, may indicate how the project is meeting its service level agreements (SLAs), e.g., with respect to maintenance tickets (requests). The data such as how many tickets for each priority level were fixed within the SLA limit may be stored, e.g., on the cloud or like infrastructure.

Example deviations for alerts and examples of other actionable recommendations may include, but are not limited to: productivity is not improving at the expected rate; utilization is below the optimal range, e.g., 95%-99%; project spread is not good with majority of cells working on same project; actual effort is off the estimation by significant amount in considerable number of tasks; some cells are more loaded than the others; some practitioners are more loaded than the others; too many work breakdown structure (WBS) templates with very few instances of each.

A monitoring system of the present disclosure in one embodiment, e.g., a global delivery monitoring system for continuous improvement for operation and process, may be designed to track social network and traditional metrics, and report whether any deviation is happening in a system being monitored. Continuous monitoring enables early detection and timely correction which ensures continuous improvement. Traditional KPIs may be insufficient to track metrics like capturing the interests of practitioners and predicting the projects and technologies that they may want to work in without having the practitioners state so explicitly. In this regard, social networks based on communities and forums to which the practitioners subscribe can be used. Social networks may also be useful in team constitution decisions. For example, if a node representing a practitioner in a network is subscribed to a skill of type interest and the active subscription to a project does not require that skill, then the node should be considered for a project requiring the skill that it is interested in. This kind of monitoring helps improve practitioner motivation. As another example, the nodes with low closeness centrality and high closeness centrality may be found, and it may be ensured that practitioners with high closeness centrality are distributed across teams in order to have balanced teams. Additionally, there can be combined ways of monitoring the system that use both SNA and traditional KPIs. For example, if a node with high betweenness centrality has much higher load than other nodes that it works with, another node may be introduced to reduce its load and also dependency. Similar process can be repeated for low utilization and productivity.

For providing a global delivery model augmented with social network analysis for continuous improvement for operation and process, in one embodiment of the present disclosure, asocial network may be formed or built that links practitioner (e.g., delivery engineers), e.g., by community (e.g., forums), project, geolocation, organization (e.g., specialization group, cell/cluster), and/or skill Analyzing the social network can provide answers to questions like: How highly connected is a node within a network? What is a node's overall impact in a network? How central is a node within a network? How does information flow within a network? Such information may be useful for improving operations and process like work allocation and team formation.

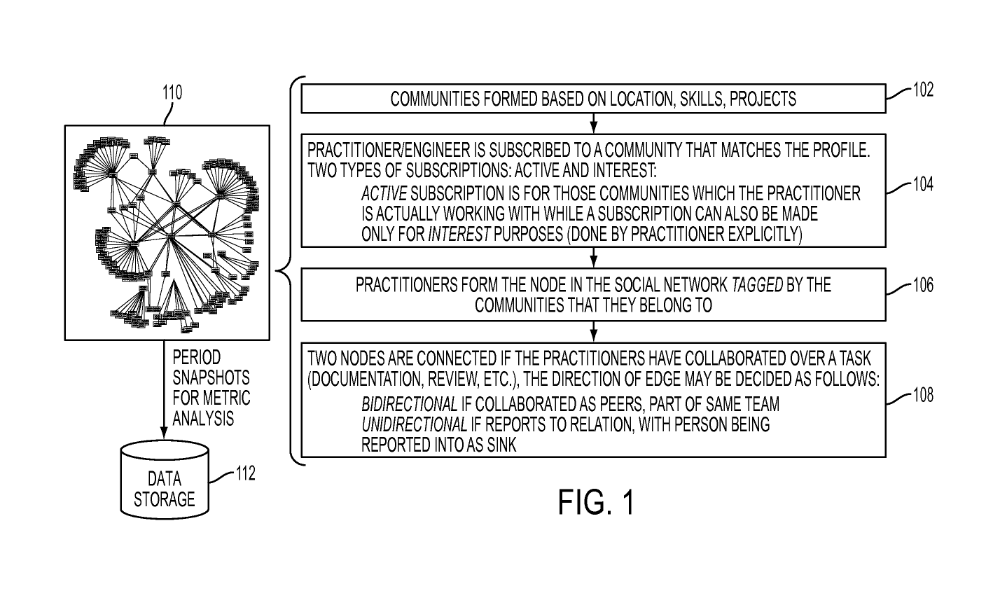

FIG. 1 is a diagram illustrating creation of a social network in a global delivery system. At 102, communities may be formed based on location, skills, and projects. At 104, a practitioner such as an engineer may subscribe to a community that matches the profile of the practitioner. For example, there may be two types of subscriptions: active and interest. Active subscription is for those communities with which the practitioner is actually working, while a subscription can also be made only for interest purposes. At 106, practitioners form the node in the social network, e.g., tagged (e.g., annotated) by the communities or by other groups that they belong to. At 108, an edge (link) is created between two practitioners if they have collaborated over a task (e.g., documentation, review etc.). The direction of the edge may be decided as follows: Bidirectional if collaborated as peers, part of same team; Unidirectional if reports to relation, with person being reported into as sink. Nodes and links so built may make up a social network 110, and over time, it may grow. Periodic snapshot of the social network 110 may be taken and saved or stored in data storage 112. Hence, updates to the network 110 may be stored, e.g., periodically, to reflect the changes so the latest information would be available for analysis. The network 110 may be analyzed for a specified set of communities by restricting the tagging or by restricting the nodes, in which case only the nodes that have the tags in that set are considered. Such a network 110 may be amenable to all the standard SNA and measures.

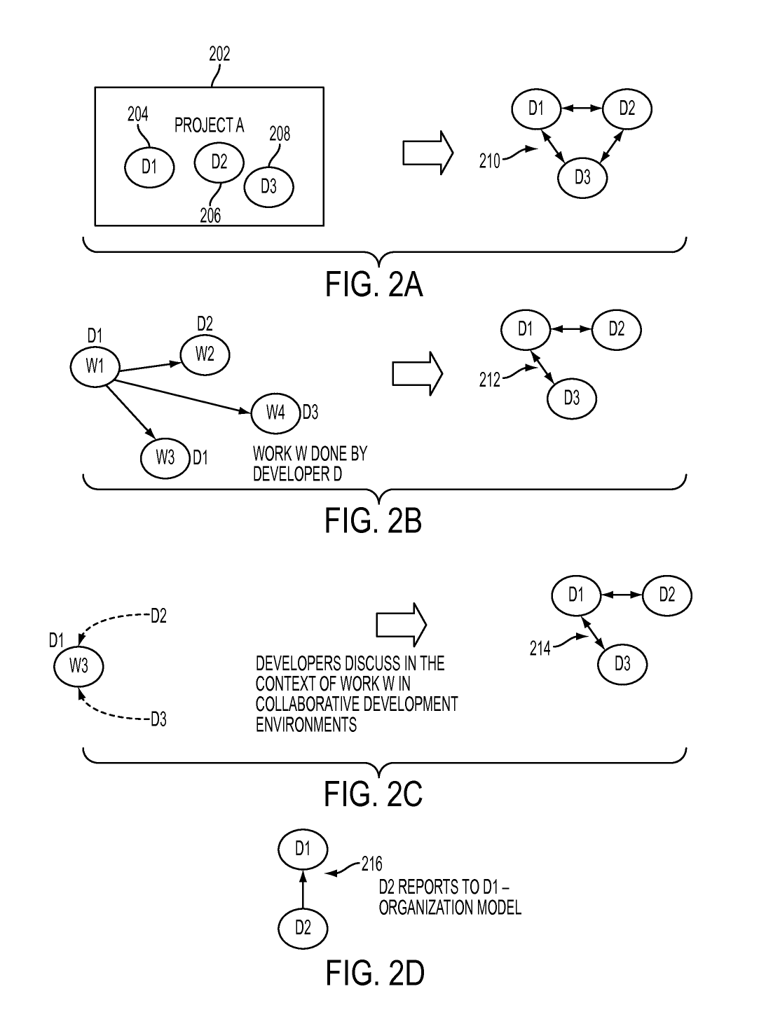

FIGS. 2A, 2B, 2C and 2D illustrate building a social network of practitioner, e.g., developers or delivery engineers. In FIG. 2A, a project 202 has developer D1 204, developer D2 206, and developer D3 208 working on it, or put another way, D1 204, D2 206 and D3 208 are team members working on the same project 202. Each of the developers may be represented as a node in a network in the same community (e.g., community of developers). Edges are created to link each of the developers to the other developers as shown at 210 to represent that they are collaborating, working on the same project 202.

In FIG. 2B, D1 works on work packet W1 and W3, D2 works on W2, D3 works on W2. Work pacekt W1 is related to W2, W3 and W4. Hence, the developers who work on related work packets also are linked. For example, an edge is created between D1 and D2 nodes, and an edge is created between D1 and D3 nodes as shown at 212.

FIG. 2C shows a diagram illustrating a scenario in which developers discuss work in the context of work packet W1 in collaborative development environments. For example, D1 works on W1. D2 discusses W1 with D1, and D3 discusses W1 with D1. Hence at 214, D1 and D2 are linked with an edge and D1 and D3 are linked with an edge as shown at 214.

FIG. 2D shows a diagram illustrating an organization model. In this diagram D2 reports to D1. Hence, a one-way directional edge representing such reporting scenario links D2 to D1 as shown at 216.

A practitioner social network of the present disclosure in one embodiment may be also built based on communication channels between workforce and customers and the outside world, e.g., support communities. Such social network may be used for incident management, for example to discover implicit social networks and encourage collaboration (e.g., in resolving an application incident among multiple workgroups), and leverage collective intelligence for diagnosis, seek right experts and expertise across workforce functional boundaries, analyze various information sources to build knowledge per topic and establish topic associations. Such social network may be also used for application development, e.g., to monitor delivery performance through social characteristics.

In one aspect, deliverables are processed by shared resources that collaborate on delivery, e.g., hand-off of intermediate results, review of specifications or code, and integration of sub-components. Delivery excellence is typically measured through traditional metrics, such as: effort and schedule variation, cost of quality/poor quality, delivered defect density, defect removal efficiency. Adding monitoring of SNA metrics (e.g., centrality, bridge, density, structural holes, distance) and determining correlation between SNA metrics and traditional KPIs may further aid in delivery improvement. For instance, correlated SNA metrics may be used to: derive task-task and person-person synergy for capacity planning; facilitate team formation, policy decisions (e.g., max project spread for resources), and other network-related actions; target corrective actions (e.g., training) for individual deviations.

Social network analysis metrics for global service delivery model may include, but are not limited to, degree of centrality, betweenness centrality, closeness centrality, eigenvalue, and authority.

Degree centrality is the number of direct relationships that a practitioner or a node in a social network has. For example, A node (e.g., an engineer) with high degree centrality: is generally an active player in the network; is often a connector or hub in the network; is not necessarily the most connected node (e.g., engineer) in the network (an engineer may have a large number of relationships, the majority of which point to low-level nodes (e.g., engineers)); may be in an advantaged position in the network; may have alternative avenues to satisfy organizational needs, and consequently may be less dependent on other individuals; can often be identified as third parties or deal makers.

Betweenness centrality identifies a node's (e.g., an engineer's) position within a network in terms of its ability to make connections to other pairs or groups in a network. A node (e.g., an engineer) with a high betweenness centrality generally: may hold an influential position in the network; may represent a single point of failure—e.g., if the node is taken out of a network, ties may be broken severed between those that linked through this node; may have a greater influence over what happens in a network.

Closeness centrality measures how quickly a node (e.g., an engineer) can access more nodes (e.g., engineers) in a network. A node (e.g., an engineer) with a high closeness centrality generally: has quick access to other entities in a network; has a short path to other entities; is close to other entities or communities of nodes; has high visibility as to what is happening in the network.

Eigenvalue measures how close a node (e.g., an engineer) is to other highly close nodes (e.g., engineers) within a network. Eigenvalue identifies the most central nodes (e.g., engineers) in terms of the global or overall makeup of the network. A high Eigenvalue generally: indicates a node (e.g., an actor) that is more central to the main pattern of distances among all nodes (e.g., engineers); is a reasonable measure of one aspect of centrality in terms of positional advantage.

An authority is a node that many other nodes point to. For example, engineers that many other engineers point to are called authorities. If a node (e.g., an engineer) has a high number of relationships pointing to it, it has a high authority value, and generally: is a knowledge or organizational authority within a domain; acts as definitive source of information.

In one aspect, the social network analysis (SNA) metrics for global service delivery model may operate not only on the level of individuals, but also at the level of groups. A method of the present disclosure may also utilize Laplacian eigenmode-based functional subgraph prediction, which is a method for using spectral anaylsis of network structure to determine which nodes naturally go together in terms of information flow. Such natural groupings of nodes may comprise nodes (people) that frequently work together and do it well in terms of hierarchy, past performance, or past interaction.

Continuous improvement by using social network analysis (SNA) as well as traditional metrics analysis may use SNA to monitor teams and team members by appropriate interpretations of the SNA metrics. In one embodiment of the present disclosure, the social network analysis determines if there is a scope of improvement through teams and additional social information. In case any deviation is detected during the determination (e.g., a monitoring routine that performs the determination), both the following checks may be performed: Operational and process checks to find scope for corrective actions to mitigate the deviation; and SNA to determine if teams need to be reorganized and to what extent. The decision for which a corrective action to take in case of ambiguity may lie with an authority node. In one embodiment of the present disclosure, the combination of SNA and traditional metrics may be carried out as follows: Traditional metric may be used as a primary indicator to detect deviation and one or more SNA metrics may be used to diagnose the possible cause; Traditional metric may be used as a primary indicator to detect deviation and one or more SNA metrics may be used to determine one or more recommendations for corrective actions.

The following illustrates examples of using SNA metrics for determining improvement, e.g., in operations and/or processes of global delivery service. Degree centrality as a metric indicates the number of team members (nodes) that a practitioner (node) would have interacted with, in the course of the practitioner's work. In one embodiment of the present disclosure, the degree centrality is computed for distinct roles (represented in the nodes) in a system (social network). As an example, assume that the target degree centrality is equal to the size of two teams roughly of same size. To detect deviation, e.g., a methodology of the present disclosure in one embodiment may identify one or more nodes (practitioners) with a degree centrality that deviates from the median degree centrality of other practitioners belonging to the same role and having worked with similar team size. Such deviation may signal too much or too little interactions or communication. Corrective actions based on the detected deviation may be process based. For example, an action may be to reassign to a new team that matches with the skill set (rotation policy). As another example, in case of shared delivery, an action may be to ensure that work allocation takes into account resource sharing across projects/accounts.

Another example of a SNA metric is closeness centrality. The notion of “closeness” captures the extent to which a node (practitioner) is positioned in the shortest path between other nodes (practitioners) in the network. In the present disclosure in one embodiment, closeness centrality of a developer signifies the developer's influence on other developers' channels of collaboration. For example, a subject matter expert (SME) is expected to have higher closeness centrality compared to a developer, for instance, because SME is expected to work with various teams during the course of a project. As an example of deviation, assume that the target closeness centrality for the role of SME for a reasonably big project is equal to the size of 3-4 teams assuming teams to be roughly of same size. An example of detecting a deviation may be to identify a node with a closeness centrality that deviates from the median closeness centrality of other nodes belonging to the same role and having worked with similar team size. Such deviation may indicate too much or too little interactions or communication. An example of a processed based action may include assigning the SME to another team, e.g., if the reason is team maturity.

A social network of the present disclosure for SNA may be built in one embodiment of the present disclosure that comprises nodes and links (edges). Such social network may be utilized also for shared delivery. Each node may represent a practitioner, and may be tagged by (or have an attribute of) a role the node (practitioner) has (e.g., a flexible role, a core role for a project, an SME who has expertise in multiple areas or projects), e.g., in shared service delivery. The network may be formed, e.g., as described above, e.g., with reference to FIGS. 2A-2D. Such network may be amenable to all the standard SNA and measures. In addition, the following interpretations may be applied. For instance, the following expected conditions may be monitored: a non-core member node with outgoing edges to core members and SMEs of different projects; degree centrality of SME nodess; core member nodes close to each other with edges having tuples corresponding to high complexity tasks; betweenness centrality of core member nodes that act as a bridge between SMEs and non-core teams; task type nodes with frequent communications across board in shared delivery.

The following scenarios illustrate examples of handling deviations from the above monitored results. For example, if there are many incoming edges to a non-core member node from other non-core member nodes, then this implies that this non-core member is being consulted by peers for certain projects and should be considered for moving to core team. If a non-core member node is connected to less than a defined number of core member nodes, then check work allocation mechanism. If a task type requires frequent communication, then it should be re-considered for its suitability for shared delivery model.

An example of a combined approach in one embodiment of the present disclosure may be described as follows: Productivity, e.g., may be determined based on traditional KPIs. The global service delivery model represents an industrialized approach to application development and maintenance by leveraging resource pooling. If resource pooling is not used in service delivery, the communities of such nodes may be determined. If it is observed that the majority of the low productivity nodes belong to a certain project or a skill type, then root cause analysis focused on that project or skill type may be performed to suggest one or more actions. If the nodes form a connected network, then the authority node may be determined to check for further analysis of the connected network. In case of service delivery by sharing resources, different actions such as additional training, and designing proper training material, adjusting load, may be suggested, based on whether a low productivity node is determined to be a core, non-core or SME member. Similar process can be repeated for low/unbalanced utilization nodes.

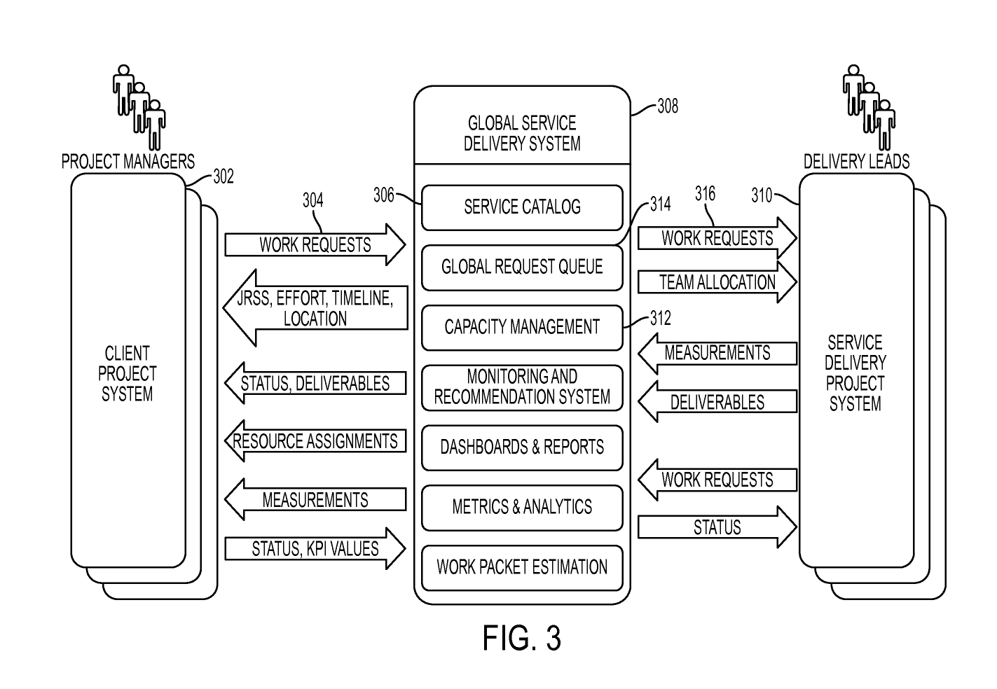

FIG. 3 illustrates a global service delivery system in one embodiment of the present disclosure. A global delivery model standardizes how work is requested, executed, and fulfilled. A client project system (CPS) 302 creates a demand for work in a form of work requests 304. The work requests 304 include deliverables that are defined in a service catalog 306. A global service delivery system (GSDS) 308 provides an integrated delivery system that is responsible for creating and updating the catalog items based on the services offered by an organization. The work requests 316 then flow to delivery teams (shown through Service Delivery Project System (SDPS)) 310 that include practitioners who carry out the work. The GSDS 308 maintains a centralized work queue 314 that contains the work requests from all projects in CPS 302. The GSDS 308 is also responsible for carrying out the work assignment done by the capacity management module 312. The GSDS 308 informs CPS 302 about the job role skill set (JRSS), location, resource assignments, etc., after processing the work requests. Measurements on deliverables/resources may be transmitted from SDPS 310 into GSDS 308 into CPS 302. The status and KPIs are transmitted to the GSDS 308 from CPS 302 and then the appropriate status information is transmitted to SDPS.

An embodiment of the present disclosure may also apply a Kaizen methodology to global service delivery model for continuous monitoring and improvement. Kaizen, which means “improvement” or “change for the better,” refers to philosophy and practices that focus upon continuous improvement of processes in manufacturing, engineering, game development, and business management. The cycle of kaizen activity (aka PDCA—plan, do, act, check) can be defined as: 1. standardize an operation and activities; 2. measure the standardized operation (e.g., find cycle time and amount of in-process inventory); 3. gauge measurements against requirements; 4. innovate to meet requirements and increase productivity; 5. standardize the new, improved operations; 6. continue cycle ad infinitum.

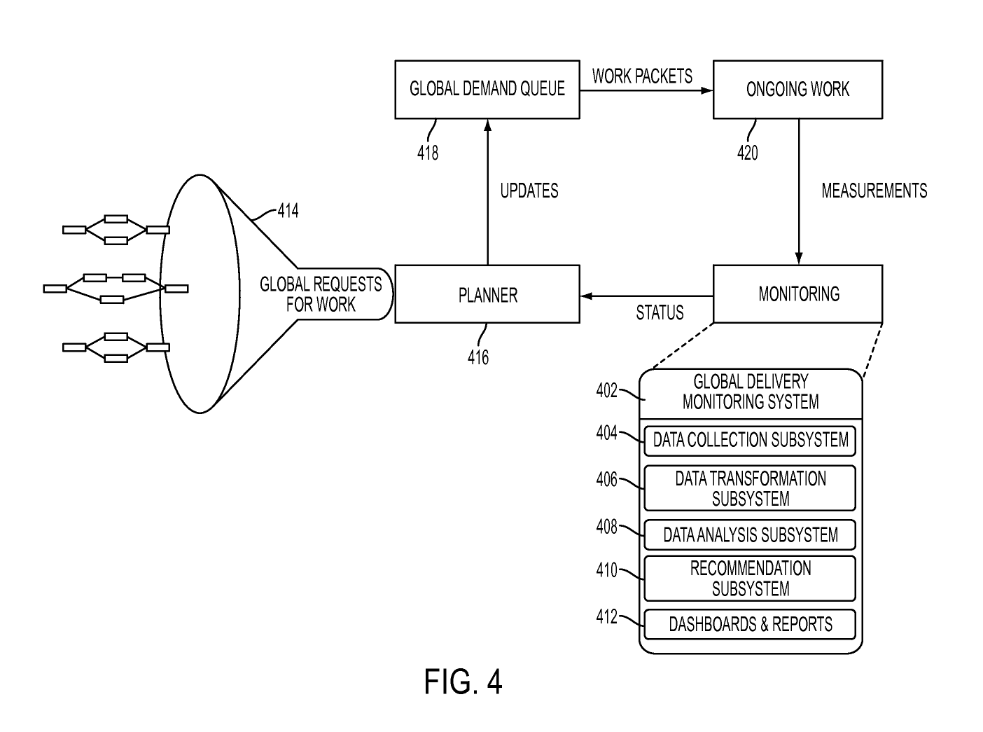

FIG. 4 illustrates a global service delivery monitoring and recommendation system comprising a global delivery model that continuously monitors ongoing work for improvement in one embodiment of the present disclosure. Global requests for work may be received as shown at 414. A planner 416 (e.g., an automatic tool) may plan the received work and place in a global demand queue 418. The queued work is then taken off the queue and performed at 420. A monitoring subsystem 402 monitors the ongoing work, and may continuously optimize the operation whenever: New requests are received; Changes are made to pending request's attributes, e.g., begin-end dates, etc.; Issues or opportunities are detected during runtime.

The monitoring system that uses SNA and traditional metrics may include the following subsystems in one embodiment of the present disclosure. A data collection subsystem 404 in one embodiment may instrument code to collect data pertinent to identified metrics and social network. The data is continuously updated for social network to maintain the most recent information. The data collection for other KPIs may depend on their required frequency.

In a data processing or transformation subsystem 406, the collected data may be processed to compute the actual metric. For example, in case of SNA, the data is collected in the form of graph, but the processed data is the actual metric like betweenness centrality.

A data analysis subsystem 408 analyzes the measured or collected metrics, for example, against benchmarks and/or given values to check whether the system is operating as expected or whether there is a deviation.

A recommendation subsystem 410 may provide, for each metric, a recommendation such as a corrective action to be performed if a deviation is observed. The recommendations can be at the level of team organization or process improvement or can also be automated actions.

A data reporting subsystem 412 may report the metrics, e.g., as normal and/or if not normal, generate associated warnings. Reporting may be provided on a dashboard or another user interface. Reporting may be generated in any other form.

Additional monitoring system to optimize work allocation and team formation may include a tracking subsystem. For example, the tracking subsystem may track the work being carried out by observing the status and amount of time (e.g., hours) spent against estimation. Any possibility of delay or early finish is detected in advance to re-plan the allocation in optimal manner.

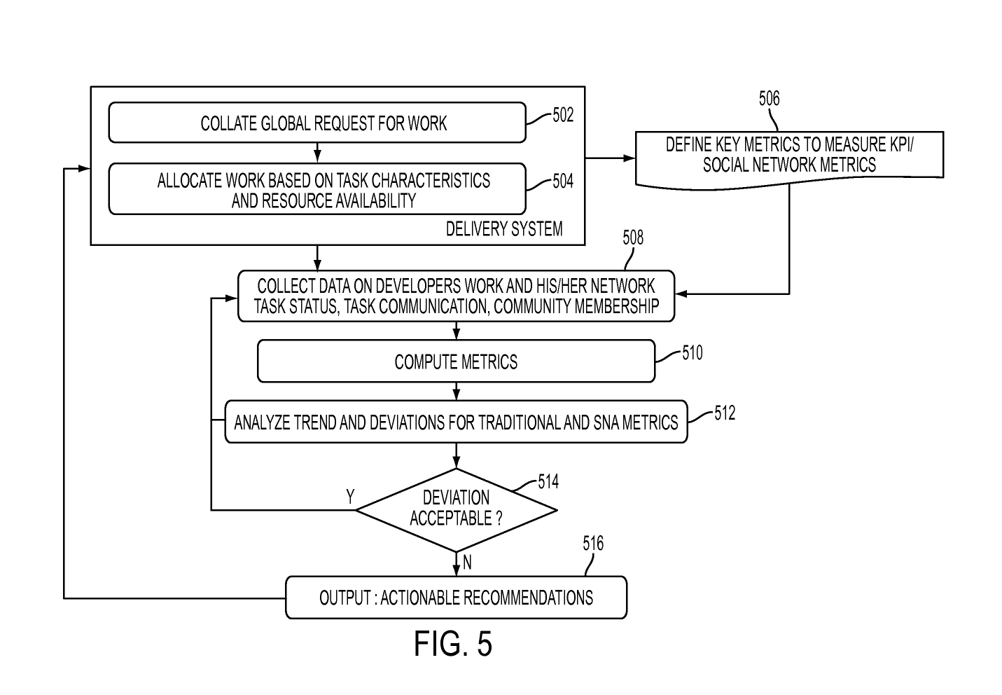

FIG. 5 is a flow diagram illustrating a method of global delivery monitoring and recommendation system implementing continuous improvement by using SNA and traditional metrics analysis in one embodiment of the present disclosure. At 502, global request for work may be collated. At 504, work may be allocated based on task characteristics and resource availability. At 506, key metrics may be defined to measure KPI and SNA. For example, key metrics may be defined based on organization's goals. Examples of KPI metrics may include, but are not limited to, productivity, utilization, load balance, project spread, estimation accuracy, and others. Further, SNA metrics may be defined.

At 508, data associated with a node (e.g., developer's work) and associated network is collected from the social network of practitioners. Examples of such data may include task status, task communication, and community membership. KPI data may be collected from monitoring of work performed. At 510, metrics may be computed. At 512, a trend and any deviations are analyzed for traditional and SNA metrics. Examples of SNA metrics may include, but are not limited to, degree centrality, betweenness centrality, closeness centrality, authorities, eigenvalue, and others. At 514, if no deviations are detected, or if a deviation is within a tolerable range (e.g., acceptable), then the processing continues to 508 where more data can be collected. If at 514, a deviation that is out of tolerable range is detected, at 516, one or more actionable recommendations may be generated and output.

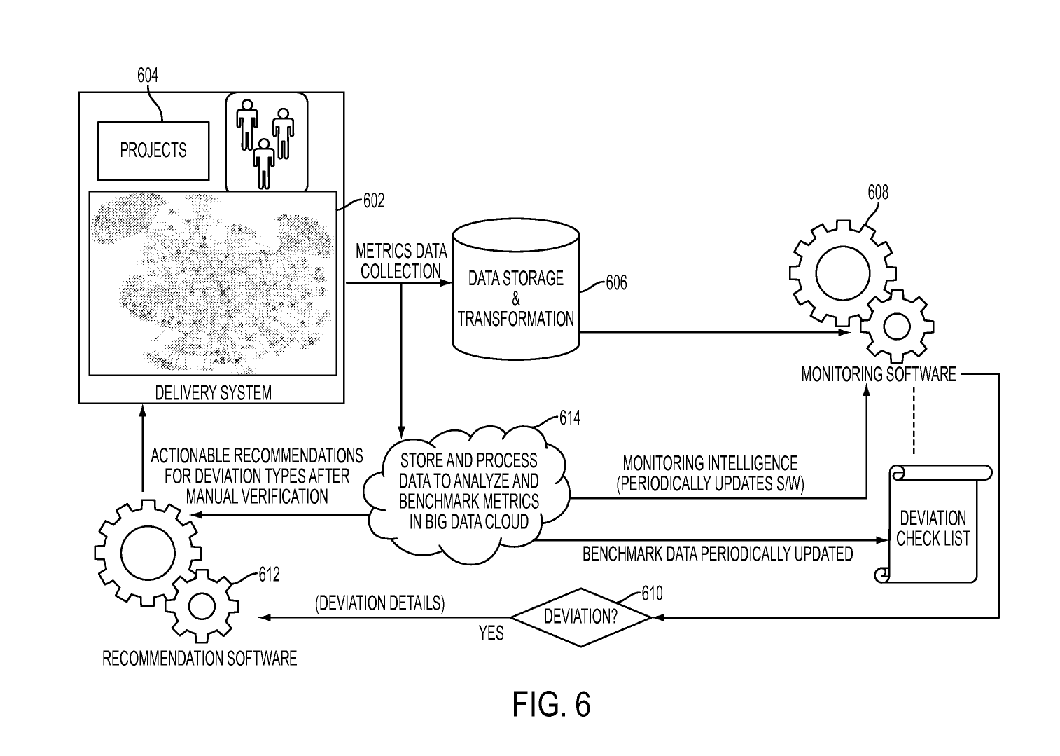

FIG. 6 is another diagram illustrating a method of global delivery monitoring and recommendation system implementing continuous improvement by using social network analysis and traditional metrics analysis in one embodiment of the present disclosure. Metrics data may be collected from a social network of practitioners 602, and information source associated with projects 604. For example, project management may mandates KPIs and operational/delivery metrics to be tracked. These metrics can be augmented with SNA metrics for analysis.

The collected data may be stored and transformed into measurable metrics at 606. Monitoring module 608 may monitor and check for deviation. If at 610, deviation is detected, a recommendation module 612 may suggest one or more mitigating actions and/or provide deviation details.

The collected data may be also stored and processed, e.g., on a storage device 614, e.g., accessible on a network infrastructure. Benchmark data (or average data or such data considered to be a norm or standard) 616 may be updated for use in determining deviations.

The following example describes a quantitative model that analyzes metrics and computes whether there are any deviations. Let {X₁, X₂, . . . , Xₙ} be the metrics that are observed. Let D_{X1} denote the data collected for a time period t pertinent to X₁ and so on. X₁=f(D_{X1}), X₂=g(D_{X2}), . . . Xₙ=h(D_{nX}) where f, g, h denote functions that are applied on the data to compute the metric values. Let X₁₁, X₁₂, . . . , X₁ₘ be the metrics X₁ at time t₁, t₂, . . . , tₘ respectively. Let ΔX₁₁, ΔX₁₂, . . . , ΔX₁ₘ be the deviations in X₁ represented as time-series at respective times. Different policies may be applicable for applying a corrective action as follows: Any unacceptable deviation at the end of time period may trigger an action; A series of unacceptable deviations may trigger an action, e.g., if a deviation is unacceptable for consecutive m time periods; Frequency of unacceptable deviation may trigger an action, the deviations do not have be consecutive. In one embodiment of the present disclosure, the deviations are computed with the latest benchmarked expected values. Techniques such as process behavior charts can be used to update the benchmark values.

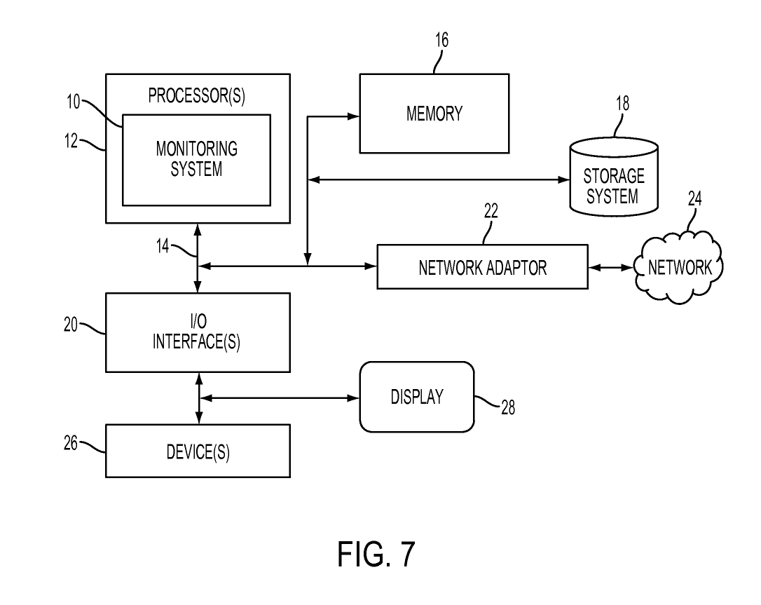

FIG. 7 illustrates a schematic of an example computer or processing system that may implement the monitoring system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a monitoring module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for improving global service delivery by augmenting with social network analysis, comprising:
identifying social network metrics and key performance indicator metrics;
collecting data associated with the social network metrics and the key performance indicator metrics, from on-going work performed in the global service delivery and a social network of practitioners;
transforming the data into measurable metric data;
determining whether a deviation exists in the measurable metric data; and
generating an actionable recommendation in response to determining that the deviation exists.

2. The method of claim 1, wherein the social network metrics comprises one or more of degree centrality, betweenness centrality, closeness centrality, authorities, eigenvalue, or combinations thereof.

3. The method of claim 2, wherein the data associated with the social network metrics comprises a graph structure associated with the social network, and the transforming comprises computing one or more of the social network metrics from the graph structure.

4. The method of claim 1, further comprising generating a report associated with the measurable metric data, including at least generating a report associated with the deviation and the actionable recommendation in response to determining that the deviation exists.

5. The method of claim 4, wherein the report is generated as a dashboard user interface.

6. The method of claim 1, further comprising tracking the work performed based on the social network metrics and key performance indicator metrics.

7. The method of claim 1, further comprising building the social network of practitioner based on communication and collaboration among the practitioners.

8. The method of claim 1, wherein the determining of whether a deviation exists in the measurable metric data comprises first determining whether a deviation in the measurable metric data associated with the key performance indicator metrics exists, and in response to determining that the deviation in the measurable metric data associated with the key performance indicator metrics exists, determining whether a deviation in the measurable metric data associated with the social network metrics exists.

9.-21. (canceled)
